(19) United States
(12) Patent Application Publication
(10) Pub. No.: US 2019/0240998 A1
(43) Pub. Date: Aug. 8, 2019

(54) PRINTER

(71) Applicant: TOSHIBA TEC KABUSHIKI KAISHA, Tokyo (JP)

(72) Inventor: Motohito Tsuchiya, Mishima Shizuoka (JP)

(21) Appl. No.: 16/244,168

(22) Filed: Jan. 10, 2019

(30) Foreign Application Priority Data
Feb. 8, 2018 (JP) 2018-021331

(51) Int. Cl. B41J 13/00; B41J 3/407; B41J 2/32

(52) U.S. Cl. CPC B41J 13/009; B41J 2/32; B41J 3/4075

(57) ABSTRACT

A cover includes one end rotatably supported by a main body. A paper holding part holds the roll paper. A printing part is provided at a position in the main body contacting with the other end of the cover to perform printing on paper. A peeling bar is provided in the other end of the cover and is located in a width direction of the pasteboard at a downstream of a paper conveyance direction of the printing part. A pressing part presses the conveyed paper to bend the paper and peels off the label from the pasteboard. A first lock part holds the cover at the closed position. A second lock part fixes the pressing part with respect to the cover. An interlocking lock releasing part releases position fixing by the second lock part and releases holding by the first lock part subsequent to the releasing.

### CROSS-REFERENCE TO RELATED APPLICATIONS

This application is based upon and claims the benefit of priority from Japanese Patent Application No. P2018-021331, filed on Feb. 8, 2018 the entire contents of which are incorporated herein by reference.

### FIELD

Embodiments described herein relate generally to a printer.

### BACKGROUND

In the related art, there is a portable printer which may be carried and used. Such a printer is equipped with a paper holding part in a housing. The housing includes a main body provided with an opening and a cover for opening and closing the opening, and the cover is opened at the time of other maintenance such as when paper is refilled or replaced.

In the above-described printer, a label adhered to a pasteboard may be peeled off and issued. In such a printer, when the label is peeled off, the pasteboard is bent and conveyed in the conveyance direction of the label.

The printer includes a peeling bar and a pressing part as a configuration for bending the pasteboard. The pressing part presses the pasteboard against the peeling bar, such that a front side (a side to which the label is adhered) of the pasteboard is bent in a mountain fold and a rear side of the pasteboard is bent in a valley fold.

In the printer of the related art, the housing is opened and closed by one operation of a user in order to improve operability. Such a printer is configured such that opening and closing of the cover and operation of the pressing part are interlocked with each other.

In the configuration in which the cover and the pressing part are interlocked with each other, the sizes or shapes of the members may be restricted such that a member attached to the cover and a member configuring the pressing part do not collide with each other when the housing is opened and closed. In particular, if the size or shape of the peeling bar is restricted, peeling performance is restricted.

### DESCRIPTION OF THE DRAWINGS

FIG. 1 is a perspective view illustrating the appearance of a printer according to an embodiment when a cover is opened;

FIG. 2 is a perspective view illustrating the appearance of the printer when the cover is closed;

FIG. 3 is a plan view illustrating the appearance of the printer in an operation state;

FIG. 4 is a vertical cross-sectional view of the printer in a state corresponding to FIG. 1;

FIG. 5 is a vertical cross-sectional view of the printer in a state corresponding to FIG. 2;

FIG. 6 is a vertical cross-sectional view of the printer in the operation state corresponding to FIG. 3;

FIG. 7 is a vertical cross-sectional view of the printer illustrating a paper conveyance path;

FIG. 8 is a vertical cross-sectional view of the printer at the time of a lock releasing operation;

FIG. 9 is a side view illustrating the appearance of a first lock part and a releasing lever;

FIG. 10 is a side view illustrating releasing operation of the first lock part by the releasing lever;

FIG. 11 is a perspective view illustrating the structure of a second lock part;

FIG. 12 is a perspective view illustrating a holding state by the second lock part; and

FIG. 13 is a perspective view illustrating releasing operation of the second lock part by the releasing lever.

### DETAILED DESCRIPTION

An exemplary embodiment provides a printer having good balance between operability at the time of opening and closing a housing and label peeling performance.

In general, according to one embodiment, a printer for performing printing on roll paper formed by winding paper in which a label including a paste layer on a rear surface of a printed surface is adhered to a band-shaped pasteboard includes a main body as a container provided with an opening, a cover including one end rotatably supported by the main body and moving from a closed position where the opening of the main body is closed to an opened position where the opening is opened, according to rotation, a paper holding part configured to hold the roll paper in the main body and to be opened and closed by the cover, a printing part provided at a position in the main body contacting with the other end of the cover to perform printing on the paper drawn out from the paper holding part, a peeling bar provided in the other end of the cover and located in a width direction of the pasteboard at a downstream of a paper conveyance direction of the printing part, a pressing part configured to press the conveyed paper to bend the paper along an outer circumferential surface of the peeling bar and to peel off the label from the pasteboard, a first lock part configured to hold the cover at the closed position, a second lock part configured to fix the pressing part with respect to the cover, and an interlocking lock releasing part configured to release position fixing by the second lock part and to release holding by the first lock part subsequent to the releasing.

### First Embodiment

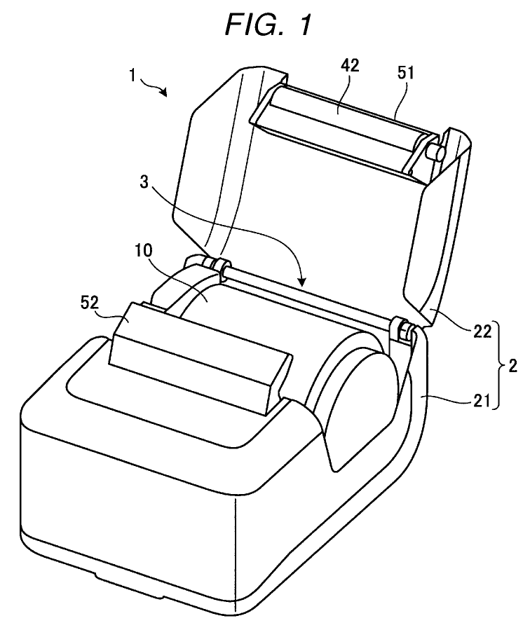

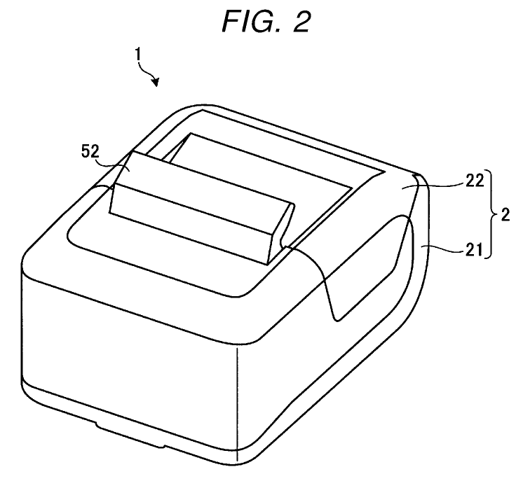

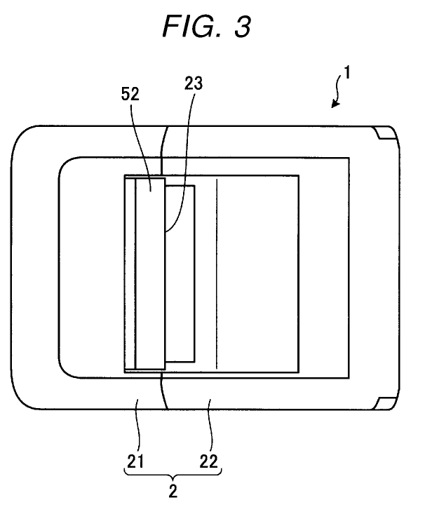

An embodiment will be described with reference to the drawings. FIG. 1 is a perspective view illustrating the appearance of a printer 1 when a cover 22 is opened, FIG. 2 is a perspective view illustrating the appearance of the printer 1 when the cover 22 is closed, and FIG. 3 is a plan view illustrating the appearance of the printer 1 in an operation state.

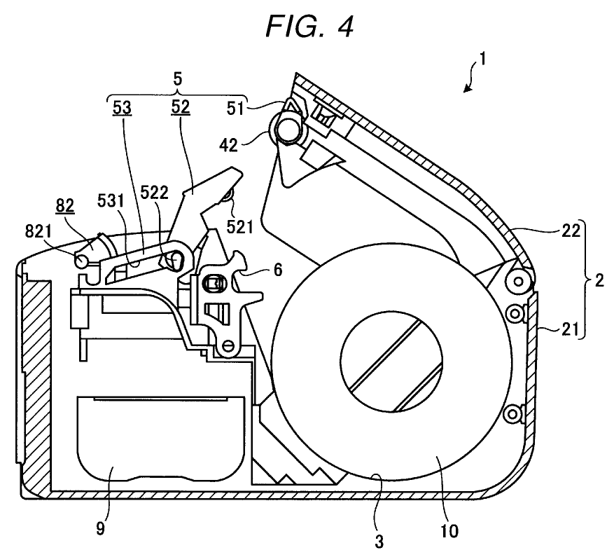

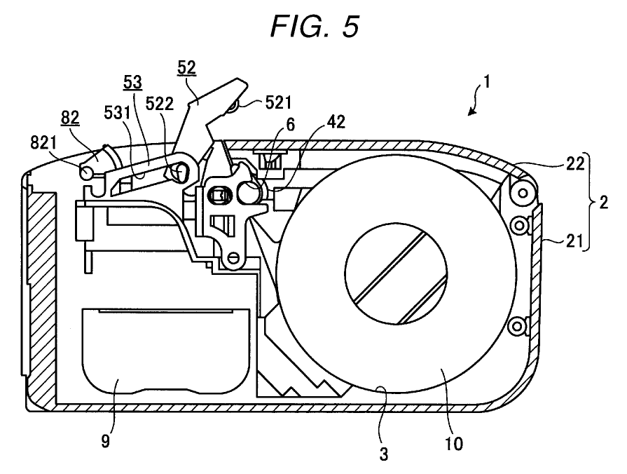

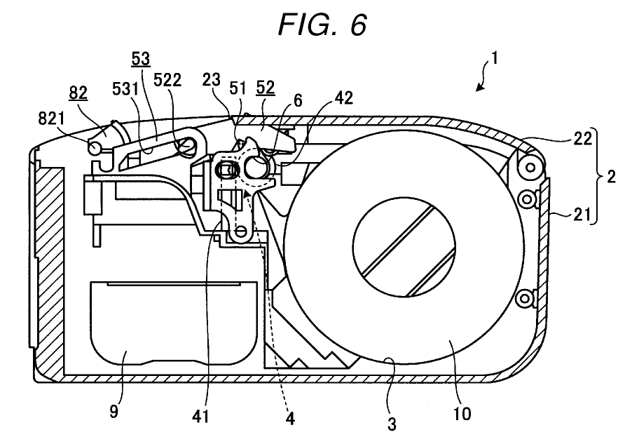

FIG. 4 is a vertical cross-sectional view of the printer 1 in a state corresponding to FIG. 1, FIG. 5 is a vertical cross-sectional view of the printer 1 in a state corresponding to FIG. 2, and FIG. 6 is a vertical cross-sectional view of the printer 1 in the operation state corresponding to FIG. 3.

The printer 1 includes a housing 2, a paper holding part 3, a printing part 4 and a peeling part 5, and performs printing on a roll paper 10. The roll paper 10 is formed by winding paper in which a label including a paste layer on a rear surface of a printed surface is adhered to a band-shaped pasteboard. The housing 2 includes a main body 21 and a cover 22 and includes the paper holding part 3, the printing part 4, the peeling part 5 and a battery 9 formed therein. The battery 9 is a secondary battery (rechargeable battery) and supplies power for operating the printer 1.

The main body 21 is, for example, a box type container including an opening. One end (rotation-side end) of the cover 22 is rotatably supported by the main body 21 and is moved between a position where the opening of the main body 21 is closed (closed position, see FIG. 6) and a position where the opening of the main body 21 is opened (opened position, see FIG. 4), according to rotation.

The paper holding part 3 is provided in the main body 21 and is opened and closed by the cover 22. In addition, the paper holding part 3 holds the roll paper 10 such that paper is drawn out.

The printing part 4 is provided at a position in the main body 21 contacting with the other end of the cover 22 (that is, a movement-side end which is an end located at the opposite side of the rotation-side end) and performs printing on the paper drawn out from the paper holding part 3. The printing part 4 includes a printing head 41 (see FIGS. 6 to 8) and a platen 42.

The printing head 41 is provided in the main body 21. The platen 42 is attached to the cover 22. In a state in which the cover 22 is closed, the platen 42 is brought into contact with the printing head 41 and the printing part 4 may perform printing.

The printing head 41 is, for example, a thermal head, and performs printing on the printed surface of the label, by heating and coloring a thermosensitive color developable layer provided in the printed surface of the label. The platen 42 is a roller, which draws paper sandwiched between the printing head 41 and the platen from the paper holding part 3 by rotation and transports the paper.

The peeling part 5 is disposed on a paper discharging port 23 to peel off the label from the pasteboard. The paper discharging port 23 is an opening for discharging printed paper with a gap formed between the movement-side end of the cover 22 at a closed position and the main body 21.

The peeling part 5 includes a peeling bar 51, a pressing part 52 and a supporting part 53. The peeling bar 51 is located along the width direction of the pasteboard at the downstream side in the paper conveyance direction of the printing part 4. The peeling bar 51 is, for example, a member formed by bending a rectangular plate member such that a short side thereof has a mounting shape. The peeling bar 51 is disposed such that the ridge of the mountain shape faces the paper discharging port 23 and is parallel to the axial direction of the platen 42 and is provided on the movement-side end of the cover 22.

The pressing part 52 is movable between a peeling position (see FIG. 6) and a retraction position (see FIG. 5) by supporting a base portion thereof by the supporting part 53 or is guided by the supporting part 53 to be movable between the peeling portion and a continuous position (not illustrated). Here, the continuous position is a position of the pressing part 52 when the paper is discharged without peeling off the label from the pasteboard.

The pressing part 52 at the peeling position illustrated in FIG. 6 presses the conveyed paper to be bent along the outer circumferential surface of the peeling bar 51 to peel off the label from the pasteboard. The pressing part 52 includes a peeling roller 521 at a front end portion thereof. Paper is sandwiched between the peeling roller 521 and the platen 42 in a state in which the pressing part 52 is located at the peeling position.

The supporting part 53 supports and guides the pressing part 52 such that the pressing part is movable between the peeling position and the retraction position or between the peeling position and the continuous position. Specifically, the supporting part 53 is a member including a fitting groove 531, into which a protrusion 522 provided at the base of the pressing part 52 is fitted, and the longitudinal direction of the groove 531 extends along the movement direction of the pressing part 52.

The cross-sectional shape of the protrusion 522 is not circular but has a shape close to an ellipse, and has a thickness varying according to a direction. A portion of the groove 53, in which the protrusion 522 of the pressing part 52 at the peeling position is located, is widely formed such that the protrusion 522 is rotatable and the other portion of the groove 53 is narrowly formed such that the protrusion 522 is slidably guided in a certain direction.

The pressing part 52 at the peeling position protrudes from the main body 21 to cover the peeling bar 51 and to press the paper against the peeling bar 51. In addition, the pressing part 52 at the retraction position is separated from the cover 22 not to interfere with rotation of the cover 22. That is, when the pressing part 52 is at the retraction position, the cover 22 may move to the opened position (see FIG. 4). Therefore, at least the base of the pressing part 52 at the continuous position is accommodated in the main body 21 such that the front end of the pressing part does not protrude from the paper discharging port 23 and does not interfere with the peeling bar 51.

In addition, the pressing part 52 is biased by a bias member such as a spring in a direction separated from the main body 21.

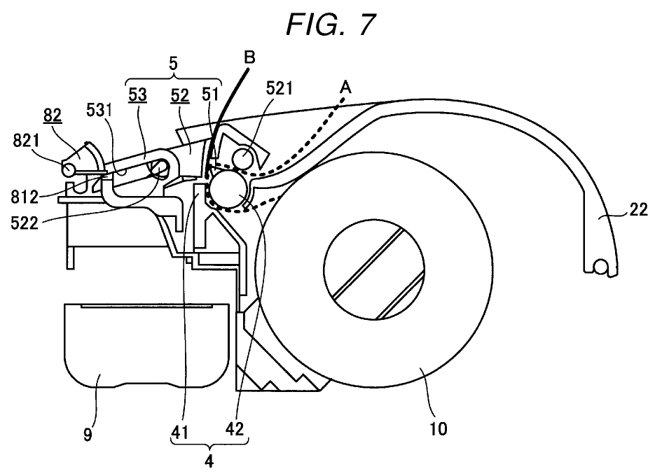

FIG. 7 is a vertical cross-sectional view of the printer 1 illustrating a paper conveyance path. In such a printer 1, the paper drawn out from the roll paper 10 held by the paper holding part 3 is subjected to printing by the printing part 4 and is discharged from the paper discharging part 23. If the pressing part 52 is at the peeling position, the pasteboard is conveyed in a path denoted by a dotted line A and the label is peeled off from the pasteboard and moved in a path denoted by a solid line B.

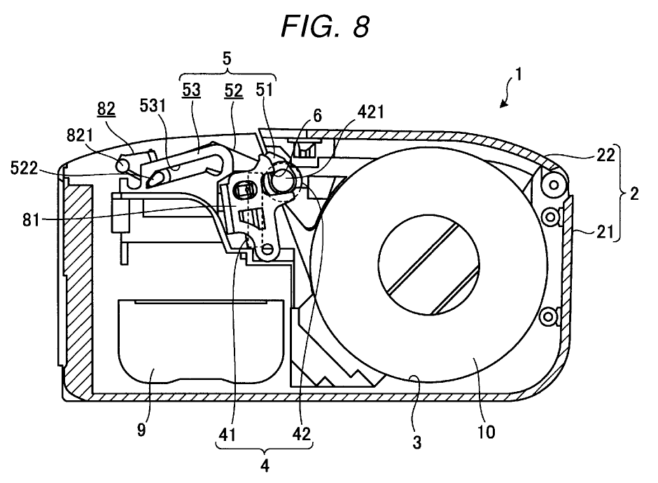

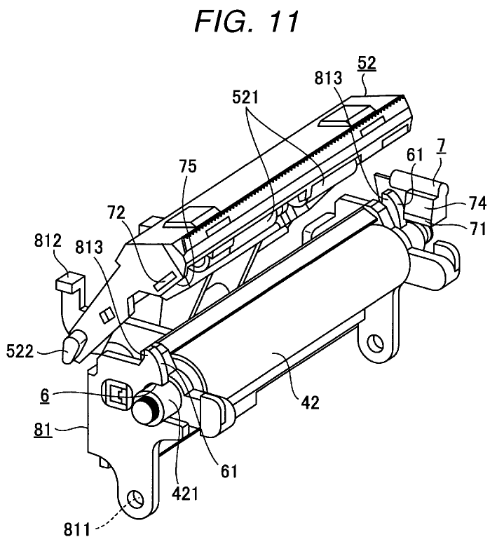

FIG. 8 is a vertical cross-sectional view of the printer 1 at the time of a lock releasing operation. The printer 1 further includes a pair of first lock parts 6, a pair of second lock parts 7 (see FIGS. 11 to 13, described below) and an interlocking lock releasing part 8. The first lock parts 6 and the second lock parts 7 are disposed in the vicinities of both ends of the platen 42 inside the housing 2.

The first lock parts 6 hold the cover 22 at a closed position. The second lock parts 7 fix the pressing part 52 at the peeling position with respect to the cover 22. The interlocking lock releasing part 8 releases position fixing by the second lock parts 7 using operation of a user as a power source and then releases holding by the first lock parts 6 subsequent to the releasing.

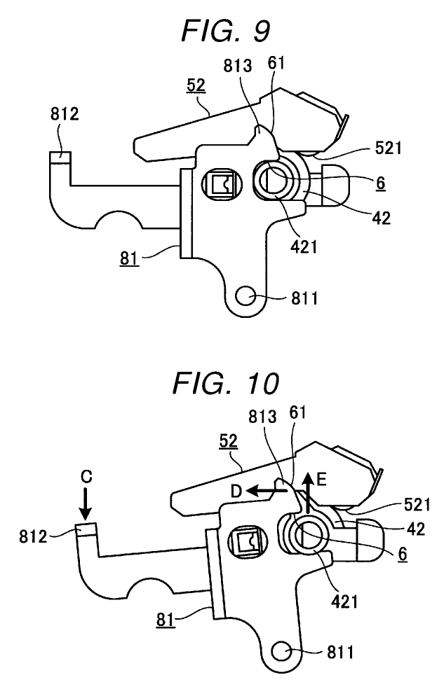

FIG. 9 is a side view illustrating the appearance of the first lock part 6 and a releasing lever 81. The interlocking lock releasing part 8 includes a pair of releasing levers 81 and a releasing button 82. The releasing lever 81 is an example of a releasing member.

The releasing button 82 is a button which rotates around a supporting point 821. The releasing button 82 is partially exposed to the outside of the housing 2 to receive pressing operation from the user and to deliver pressing to the pair of releasing levers 81. The releasing button 82 is biased by the biasing member such as the spring in a counterclockwise direction of FIG. 8 and is returned to the state illustrated in FIG. 8 if pressing operation by the user is not performed.

The releasing lever 81 may rotate around the supporting point 811 and is biased by the bias member such as the spring in a clockwise direction of FIG. 8. The first lock parts 6 are integrated with the releasing levers 81. In addition, the releasing lever 81 has a protruding end 812 disposed at a position where pressing operation applied to the releasing button 82 is received.

In addition, the cover 22 is biased by the bias member such as the spring in a direction separated from the main body 21.

The first lock part 6 is a recess which grips the end of the shaft 421 of the platen 42. The recess and the shaft 421 are engaged with each other such that the platen 42 is positioned with respect to the main body 21. Therefore, the cover 22 attached with the platen 42 is positioned with respect to the main body 21 to hold the cover 22 at the closed position.

FIG. 10 is a side view illustrating releasing operation of the first lock part 6 by the releasing lever 81. If the user presses the releasing button 82, this operation (arrow C) is delivered to the protruding end 812 such that the releasing lever 81 rotates around the supporting point 811 in a counterclockwise direction (arrow D). Since the first lock part 6 is integrated with the releasing lever 81, gripping of the shaft 421 is released according to rotation of the releasing lever 81. The shaft 421 released from the first lock part 6 is moved in a direction, in which the cover 22 is opened, by biasing by the bias member (arrow E).

Here, a guide 61 is provided at a position closer to the cover 22 than the first lock parts 6. The guide 61 guides the shaft 421 of the platen 42 to the first lock part 6 and is realized by an inclined surface provided on the outer circumferential surface of the releasing lever 81 in the embodiment.

When the cover 22 is closed, the outer circumferential surface of the shaft 421 moved together with the cover 22 slides to the guide 61 to rotate the releasing lever 81 in the counterclockwise direction. The shaft 421 is guided to the first lock part 6 by the guide 61. If the shaft 421 is fitted into the first lock part 6, the releasing lever 81 rotates in the clockwise direction and returns to the position illustrated in FIG. 9.

FIG. 11 is a perspective view illustrating the structure of the second lock part 7, and FIG. 12 is a perspective view illustrating a holding state by the second lock part 7. The second lock parts 7 are disposed in the vicinities of both ends of the platen 42 inside the housing 2 and have a convex portion 71. The pressing part 52 includes a concave portion 72, into which the convex portion 71 is fitted. The second lock part 7 may rotate around a rotation shaft 73 and is biased by a bias member such as a spring in a direction in which the side end of the pressing part 52 is pressed.

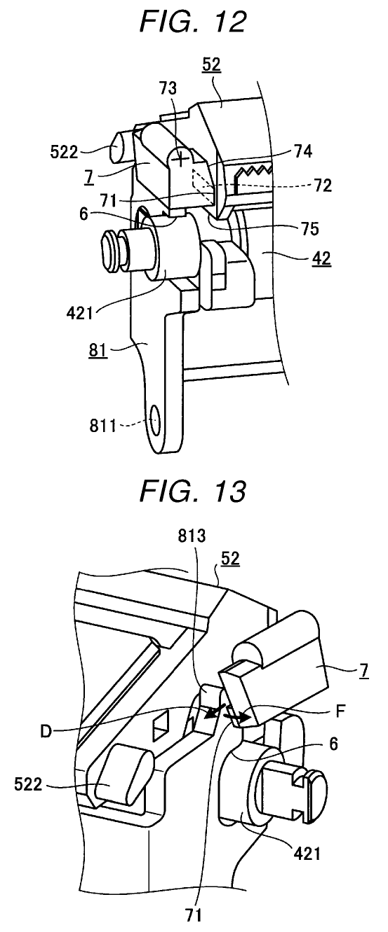

FIG. 13 is a perspective view illustrating releasing operation of the second lock part 7 by the releasing lever 81. The releasing lever 81 includes a protruding end 813 in the vicinity of a position where the second lock part 7 and the pressing part 52 are in pressure contact with each other. The protruding end 813 interferes with the second lock part 7 when the releasing lever 81 moves in a direction denoted by arrow D, and rotates the second lock part 7 against biasing force in a direction denoted by arrow F. Therefore, lock by the second lock parts 7 is released such that the pressing part 52 is separable from the platen 42.

As illustrated in FIGS. 11 and 12, the second lock part 7 includes a guide 74 and the pressing part 52 includes a guided part 75. The guide 74 is an inclined surface near the pressing part 52 in a direction in which the pressing part 52 moves from the retraction position to the peeling direction. When the pressing part 52 moves from the retraction position to the peeling position, the guided part 75 slides to the guide part 74 and the second lock part 7 rotates in a direction denoted by arrow F (see FIG. 13). When the convex portion 71 is fitted into the concave portion 72, the pressing part 52 is fixed at the peeling position.

Although the interlocking lock releasing part 8 releases both lock (holding) by the first lock part 6 and lock (position fixing) by the second lock part 7 using operation of the user as a power source, two lock releasing operations are not simultaneously performed, and the shape of the releasing lever 81 is adjusted such that position fixing by the second lock part 7 is first released and then holding by the first lock part 6 is released. That is, the position of the protruding end 813 with respect to the supporting point 811 and the position of the portion switched from the guide 61 to the first lock part 6 are adjusted.

More specifically, the releasing lever 81 has a shape for realizing a structure for shifting two lock timings and sequentially performing releasing, that is, a structure in which the first lock part 6 releases gripping of the shaft 421 when the releasing lever 81 further rotates after the protruding end 813 rotates the second lock part 7.

By such a structure, the interlocking lock releasing part 8 performs releasing of holding by the first lock part 6 and releasing of position fixing by the second lock part 7 at two positions where angles of rotation around the supporting point 811 are different from each other.

Next, operation of opening the housing 2 of the printer 1 will be described. If the releasing button 82 is pressed, pressing force is delivered to the protruding end 812 such that the releasing lever 81 rotates around the supporting part 811.

According to rotation of the releasing lever 81, first, lock by the second lock part 7 is released such that the pressing part 52 rotates by biasing of the bias member in a direction separated from the platen 42.

When the releasing lever 81 further rotates, lock by the first lock part 6 is released subsequent to releasing of lock by the second lock parts 7 such that the cover 22 rotates by biasing of the bias member in a direction separated from the main body 21.

As described above, the printer 1 receives one operation of pressing the releasing button 82 by the user and opens the housing 2.

Next, operation when the housing 2 of the printer 1 is closed will be described. When the cover 22 moves from the opened position to the closed position, the shaft 421 of the platen 42 is guided to the guide 61 to be fitted into the first lock part 6, thereby maintaining the cover 22 at the closed position.

Subsequently, when the pressing part 52 moves from the retraction position to the peeling position, the convex portion 71 of the second lock part 7 is fitted into the concave portion 72 of the pressing part 52, such that the pressing part 52 is fixed with respect to the cover 22.

As described above, in the printer 1 of the embodiment, even if operations of the pressing part 52 and the cover 22 when opening the housing 2 are interlocked to open the housing 2 through one action, the movement timing of the pressing part 52 and the movement timing of the cover 22 are shifted. In addition, in the printer 1 of the embodiment, when the housing 2 is closed, the cover 22 moves to the closed position and then the pressing part 52 moves to the peeling position to be covered by the cover 22. Therefore, it is possible to avoid interference between the member configuring the pressing part 52 and the member attached to the cover 22. Since the degree of freedom of the shape or size of the peeling bar 51 increases, it is possible to configure the printer 1 having excellent peeling performance.

In the printer of the related art, in interlocking movement of the pressing part with opening and closing of the cover, the shape or size of the peeling bar located in the vicinity of the platen attached to the cover is restricted such that interference with the peeling roller provided in the pressing part is not caused and thus peeling performance is also restricted. Although the peeling bar preferably has a shape which allows a pasteboard to be bent at an acute angle, it is difficult for the printer of the related art to perform the above-described operation.

In contrast, in the printer 1 of the embodiment, even if operations of the pressing part 52 and the cover 22 when opening the housing 2 are interlocked, operation timings are shifted, thereby avoiding interference therebetween and the pressing part and the cover are separately closed when the housing 2 is closed. Therefore, the size or shape of the member such as the peeling bar 51 is not restricted, and the peeling bar 51 having a shape which allows the pasteboard to be bent at an acute angle is easily installed, thereby improving peeling performance.

Although the first lock part 6 and the interlocking lock releasing part 8 are integrally provided (the first lock part is integrated with the releasing lever 81) in the above-described embodiment, the embodiments are not limited thereto and any structure for realizing interlocking in which timings are shifted may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer for printing on roll paper in which a label including a paste layer on a rear surface of a printed surface is adhered to a band-shaped pasteboard, the printer comprising:
a main body having an opening;
a cover including one end rotatably supported by the main body and moving from a closed position where the opening of the main body is closed to an opened position where the opening of the main body is opened, according to rotation;
a paper holding part configured to hold the roll paper in the main body and to be opened and closed by the cover;
a printing part provided at a position in the main body contacting with the other end of the cover to print on the paper drawn out from the paper holding part;
a peeling bar provided at the other end of the cover and located in a width direction of the pasteboard at a downstream of a paper conveyance direction of the printing part;
a pressing part configured to press the conveyed paper to bend the paper along an outer circumferential surface of the peeling bar and to peel off the label from the pasteboard;
a first lock part configured to hold the cover at the closed position;
a second lock part configured to fix the pressing part with respect to the cover; and
an interlocking lock releasing part configured to release position fixing by the second lock part and to release holding by the first lock part subsequent to the releasing.

2. The printer according to claim 1, wherein
the interlocking lock releasing part includes a releasing member that is rotatable around a predetermined supporting point and releases holding by the first lock part and position fixing by the second lock part at positions where rotation angles are different from each other.

3. The printer according to claim 1, wherein
the printing part comprises a printing head provided in the main body and a platen attached to the cover and brought into contact with the printing head when the cover is at the closed position, and
the peeling bar is attached to the cover to face a paper discharging port formed between the cover at the closed position and the main body.

4. The printer according to claim 1, wherein
the interlocking lock releasing part includes a releasing button configured to receive operation of a user from the outside of the main body.

5. The printer according to claim 1, wherein
the pressing part is movable to a continuous position which does not interfere with the peeling bar for discharging the paper without peeling off the label from the pasteboard.

6. The printer according to claim 3, wherein
the platen comprises a roller.

7. The printer according to claim 1, wherein
the printing part comprises a thermal head.

8. A portable printer for printing on a label adhered to roll paper, the portable printer comprising:
a main body having an opening;
a cover including one end rotatably supported by the main body and moving from a closed position where the opening of the main body is closed to an opened position where the opening of the main body is opened, according to rotation;
a paper holding part configured to hold the roll paper in the main body and to be opened and closed by the cover;
a printing part provided at a position in the main body contacting with the other end of the cover to print on the paper drawn out from the paper holding part;
a peeling bar provided at the other end of the cover and located in a width direction of the roll paper at a downstream of a paper conveyance direction of the printing part;
a pressing part configured to press the conveyed paper to bend the paper along an outer circumferential surface of the peeling bar and to peel off the label from the roll paper;
a first lock part configured to hold the cover at the closed position;
a second lock part configured to fix the pressing part with respect to the cover; and
an interlocking lock releasing part configured to release position fixing by the second lock part and to release holding by the first lock part subsequent to the releasing.

9. The portable printer according to claim 8, wherein
the interlocking lock releasing part includes a releasing member that is rotatable around a predetermined supporting point and releases holding by the first lock part and position fixing by the second lock part at positions where rotation angles are different from each other.

10. The portable printer according to claim 8, wherein
the printing part comprises a printing head provided in the main body and a platen attached to the cover and brought into contact with the printing head when the cover is at the closed position, and
the peeling bar is attached to the cover to face a paper discharging port formed between the cover at the closed position and the main body.

11. The portable printer according to claim 8, wherein
the interlocking lock releasing part includes a releasing button configured to receive operation of a user from the outside of the main body.

12. The portable printer according to claim 8, wherein
the pressing part is movable to a continuous position which does not interfere with the peeling bar for discharging the paper without peeling off the label from the roll paper.

13. The portable printer according to claim 10, wherein
the platen comprises a roller.

14. The portable printer according to claim 8, wherein
the printing part comprises a thermal head.

15. A label printer for printing on a label adhered to roll paper, the label printer comprising:
a main body having an opening;
a cover including one end rotatably supported by the main body and moving from a closed position where the opening of the main body is closed to an opened position where the opening of the main body is opened, according to rotation;
a paper holding part configured to hold the roll paper in the main body and to be opened and closed by the cover;
a printing part provided at a position in the main body contacting with the other end of the cover to print on the paper drawn out from the paper holding part;
a peeling bar provided at the other end of the cover and located in a width direction of the roll paper at a downstream of a paper conveyance direction of the printing part;
a pressing part configured to press the conveyed paper to bend the paper along an outer circumferential surface of the peeling bar and to peel off the label from the roll paper;
a first lock part configured to hold the cover at the closed position;
a second lock part configured to fix the pressing part with respect to the cover; and
an interlocking lock releasing part configured to release position fixing by the second lock part and to release holding by the first lock part subsequent to the releasing.

16. The label printer according to claim 15, wherein
the interlocking lock releasing part includes a releasing member that is rotatable around a predetermined supporting point and releases holding by the first lock part and position fixing by the second lock part at positions where rotation angles are different from each other.

17. The label printer according to claim 15, wherein
the printing part comprises a printing head provided in the main body and a platen attached to the cover and brought into contact with the printing head when the cover is at the closed position, and
the peeling bar is attached to the cover to face a paper discharging port formed between the cover at the closed position and the main body.

18. The label printer according to claim 15, wherein
the interlocking lock releasing part includes a releasing button configured to receive operation of a user from the outside of the main body.

19. The label printer according to claim 15, wherein
the pressing part is movable to a continuous position which does not interfere with the peeling bar for discharging the paper without peeling off the label from the roll paper.

20. The label printer according to claim 15, wherein
the printing part comprises a thermal head.
